(19) United States
(12) Patent Application Publication
(10) Pub. No.: US 2002/0036455 A1
(43) Pub. Date: Mar. 28, 2002

(54) Colour display tube with improved shadow mask

(75) Inventors: Daniel Den Engelsen, Eindhoven (NL); Ivo Maria Martinus Durlinger, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/961,989

(22) Filed: Sep. 24, 2001

(30) Foreign Application Priority Data
Sep. 25, 2000 (EP) 00203319.9

(51) Int. Cl. H01J 29/07

(52) U.S. Cl. 313/402

(57) ABSTRACT

In a colour display tube (1), the shadow mask (13) serves as the colour selective element. The major part of the electrons emitted by the electron gun (10) are intercepted by the shadow mask (13). These electrons can be absorbed by the shadow mask (13) or they can be reflected. In the first situation, where the electrons are absorbed, the shadow mask (13) is heated as a result of which it will be deformed, leading to misregistration of the electron beams (7, 8, 9) when they impinge upon the phosphor screen (6), causing colour impurities on the colour display tube (1). This phenomenon is commonly referred to as doming. In the second situation, where the electrons are reflected, degradation of the contrast performance takes place because the reflected electrons hit the phosphor screen (6) at totally different positions, leading to the generation of stray light. Both doming and contrast performance are important for the quality of a colour display tube (1). The problem however is that in order to optimize the doming performance, all electrons should be reflected and to optimize the contrast performance all electrons should be absorbed by the shadow mask (13). This invention provides a solution for this problem in that the shadow mask (13) is coated only at the surface at the gun side (20) with a heavy metal or an oxide thereof, having a high backscatter coefficient, which has a favorable effect on doming. Preferably, the screen side (21) of the shadow mask (13) and the walls (24, 25) of the apertures (22) are covered with a coating with a low backscatter coefficient, thereby improving the contrast in the vicinity of the position of the electron beam (7, 8, 9). In terms of visual perception a very good compromise between contrast and doming performance—i.e. colour purity—of a colour display tube (1) is achieved.

The invention relates to a colour display tube comprising an electron gun, a display window with a screen, and a colour selection electrode having a shadow mask positioned between the electron gun and the screen, which shadow mask, having a gun side and a screen side, is provided with a pattern of apertures, which apertures, at least at the gun side, are shaped like a crater, the shadow mask being provided at the gun side with a coating with a high electron backscatter coefficient and at the screen side with a coating with a low electron backscatter coefficient.

The invention further relates to a shadow mask and to a colour selection electrode for use in such a colour display tube.

The invention also relates to a method of manufacturing a shadow mask for use in a colour selection electrode intended for said colour display tube.

A colour display tube as described in the opening paragraph is disclosed in Japanese Patent Application JP 62-123635. The colour display tube according to this application is provided with a shadow mask with a coating comprising a heavy metal or an oxide thereof at the gun side of the shadow mask and with a coating comprising inorganic material at the screen side. The method of manufacturing this shadow mask is described: a mixed fluid containing an aqueous solution of water glass—which is an inorganic material—and a fine powder of Bi₂O₃—which is an oxide of a heavy metal—is sprayed on the gun side of the shadow mask. The surface tension of this mixed fluid causes the Bi₂O₃ to remain on the side where it is sprayed, whereas a capillary action ensures that the water glass flows to the screen side of the shadow mask.

However, the shadow mask according to JP 62-123635 has the disadvantage that also the walls of the apertures are covered with the heavy metal-containing coating. Electrons that hit the walls of the apertures are scattered and a part of these electrons will reach the screen. The phosphors on which they impinge emit stray light, as a result of which degradation of the contrast performance takes place, causing the overall picture quality to be spoiled.

It is an object of the invention to provide a colour display tube with an improved shadow mask that overcomes this drawback and that results in a colour display tube with an improved picture quality.

According to the present invention, this object is achieved by means of a colour display tube which is characterized in that the coating with the high electron backscatter coefficient on the gun side of the shadow mask leaves the craters of the apertures free.

The invention is based on the insight that when the coating on the gun side of the shadow mask is present only on the surface, not on the walls, of the crater-shaped apertures, the electrons are highly scattered on this surface, not on the walls, of the crater-shaped apertures. In general, the apertures in a shadow mask are obtained by a photochemical etching process, for which process the crater-shaped apertures are typical. In this context a high electron backscatter coefficient least 0.35, which means that 35% of the incident electrons are reflected. A low electron backscatter coefficient is smaller than about 0.20. For compounds the backscatter coefficient is calculated by averaging the backscatter coefficients of the individual elements weighed with their mass fractions in the compound. See: H. Niedrig, ‘Electron backscattering from thin films’ (Journal of Applied Physics 53(4), April 1982). On the one hand, the picture quality, and more in particular the contrast performance, is improved when the scattering of electrons in the apertures is kept at a low level. At least a part of the electrons scattered on the walls of the crater-shaped apertures will reach the phosphor elements on the screen and cause stray light in the neighborhood of the aperture from which they originated. On the other hand, it is of importance that the overall backscatter coefficient of the gun side of the shadow mask is high in order to prevent heating of the shadow mask caused by the electrons impinging on it. An increase in temperature of the shadow mask causes it to deform, leading to misregistrations of the electron beams, a phenomenon that is commonly referred to as doming. As a consequence, the picture quality diminishes because the picture becomes impure in colour. A very good picture quality—being a compromise between doming and contrast performance—can be obtained by coating only the surface of the shadow mask at the gun side with a material with a high backscatter coefficient and by leaving the walls of the crater-shaped apertures uncoated.

In a preferred embodiment, the coating at the gun side comprises a heavy metal or an oxide of a heavy metal, which heavy metal has an atomic number Z of at least 70. The coating of a heavy metal or an oxide thereof at the gun side of the shadow mask fulfils the demands necessary for a good compromise between doming and contrast performance, because heavy metals, due to their high atomic number, have a high backscatter coefficient.

In a further preferred embodiment, the coating at the screen side comprises a light metal or an oxide of a light metal, which light metal has an atomic number Z which does not exceed 20. The contrast performance can be further improved by applying a coating containing a light metal or an oxide thereof at the screen side of the shadow mask. Such a coating is largely electron adsorbing, so that stray light in the neighborhood of an electron that is reflected by the screen is largely prevented.

In a further embodiment, the highly backscattering coating at the gun side comprises a material of the group formed by Bi₂O₃, WO₃, WC. In practice, such materials have been found to give good results, Bi₂O₃ being preferably applied.

In a further embodiment, the slightly backscattering coating at the screen side comprises a material of the group formed by Al₂O₃, SiO₂, BN. In practice, such materials have been found to give good results; preferably, Al₂O₃ is applied.

In a still further embodiment, the craters of the apertures at the gun side of the shadow mask are coated with the coating provided on the screen side of the shadow mask. When the walls of the craters at the gun side of the shadow mask are coated with the same material as the screen side of the shadow mask, the number of electrons that are scattered by these walls are reduced, resulting in an improved contrast performance because fewer electrons from the walls of the apertures will reach the phosphor on the screen, so that the amount of stray light is reduced.

Furthermore, the invention relates to a shadow mask for use in such a colour display tube.

It is another object of the invention to give a manufacturing method for a shadow mask to be used in such a colour display tube. This method of manufacturing a shadow mask, which is formed from a sheet of metal, is characterized in that said method comprises the steps of covering the sheet of metal with a layer of a heavy metal and, subsequently, applying the pattern of apertures to said sheet of metal. When the material from which the shadow mask will be manufactured is covered—at least at the side that will become the gun side—with a coating of a heavy metal before the pattern of apertures is manufactured, it will be clear that this coating is not applied to the craters of the apertures. In this way a shadowmask is obtained having a high electron backscatter coefficient only at the surface of the gun side of the shadow mask for improving doming, while the absence of this coating from the walls of the crater-shaped apertures is beneficial to the contrast performance.

In a preferred embodiment this method is characterized in that the layer of a heavy metal is applied by evaporation, sputtering or electrochemical plating. From a variety of possible methods of applying a layer of a heavy metal, evaporation, sputtering or electrochemical plating are chosen because they enable a uniform layer thickness to be obtained. This is important because when the pattern of apertures is formed by using a standard process, the thickness of the layer of a heavy metal is responsible, amongst others, for the uniformity of the aperture size.

In a further embodiment, the pattern of apertures is applied by a photochemical etching process. The photochemical etching process is pre-eminently the standard process for applying a pattern of apertures in a shadow mask.

In a further embodiment, the method is characterized in that the layer of a heavy metal comprises tungsten (W).

The use of tungsten (W) is advantageous in that it has a high melting point. After the process of applying the pattern of apertures, in general, shadow masks are annealed at a temperature of about 700° C., which is necessary in order to be able to form a mask into the desired curved shape. This requires a coating with a heavy metal whose melting point is higher than the annealing temperature.

In a further embodiment, the method is characterized in that the layer comprising tungsten has a thickness of about 0.5 μm.

As can be inferred from H. Niedrig's, ‘Electron backscattering from thin films’ (Journal of Applied Physics 53(4), April 1982) the backscatter coefficient of layers of heavy metals does not increase further when the thickness is more than 0.5 μm.

In a still further embodiment of this method, the screen side of the shadow mask is covered with a layer with a low backscatter coefficient, which is preferably selected from a material of the group formed by Al₂O₃, SiO₂, BN. The contrast performance, especially the short distance contrast, of a colour display tube is improved by applying a coating with a low electron reflection coefficient at the screen side of the shadow mask, in order to lower the number of reflected electrons that will reach the screen and cause unwanted stray light.

These and other aspects of the invention will be apparent from and elucidated with reference to the embodiments described hereinafter.

In the drawings:

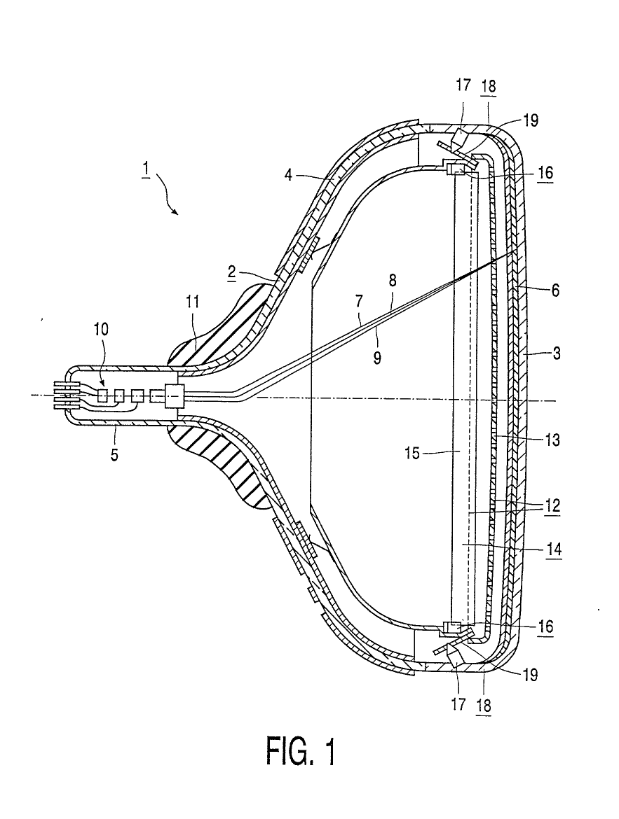

FIG. 1 is a sectional view of a colour display tube according to the invention;

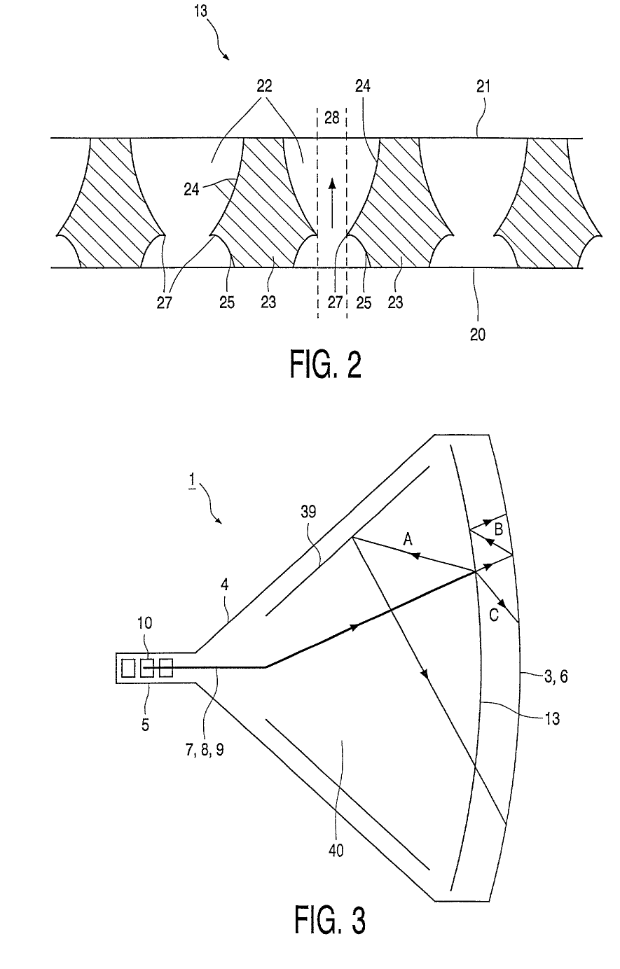

FIG. 2 is a cross-section of a small part of the shadow mask;

FIG. 3 is a cross-section of a colour display tube indicating three different electron reflection processes;

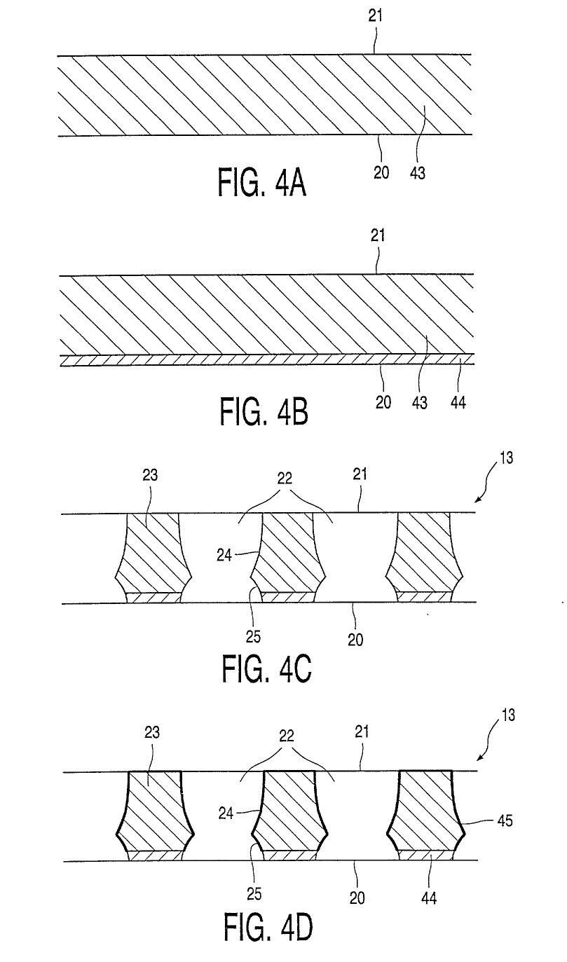

FIGS. 4A-4D are examples of the different stages in the manufacture of a shadow mask according to the invention.

The colour display tube 1 shown in FIG. 1 comprises an evacuated glass envelope 2 with a display window 3, a funnel shaped part 4 and a neck 5. On the inner side of the display window 3 a screen 6 having a pattern of for example lines or dots of phosphors luminescing in different colors (e.g. red, green and blue) may be arranged. The phosphor pattern is excited by the three electron beams 7, 8 and 9 that are generated by the electron gun 10. On their way to the screen the electron beams 7, 8 and 9 are deflected by the deflection unit 11, ensuring that the electron beams 7, 8 and 9 systematically scan the screen 6. Before the electrons hit the screen 6 they pass through a colour selection electrode 12. This colour selection electrode 12 comprises a shadow mask 13, which is the real colour selective part: it intersects the electron beams so that the electrons only hit the phosphor of the appropriate colour. The shadow mask 13 may be a mask having circular or elongate apertures, or a wire mask. Furthermore, the colour selection electrode 12 comprises the frame 14 for supporting the mask. The way the colour selection electrode 12 is suspended with respect to the display window 3 is not relevant for the present invention. As an example, FIG. 1 shows the suspension system that is referred to as corner suspension. The frame 14 is provided with corner sections 16 and with diaphragm parts 15, interconnecting the corner sections 16. By means of the suspension elements 19 which are coupled to the corner sections 16, the colour selection electrode 12 is suspended from the display window 3 by using supporting elements 17, which are secured in the upright edge of the corner areas 18 of the display window 3.

In FIG. 2 a cross-section is given of a small part of the shadow mask 13. This Figure relates to a detail at the center of the shadow mask 13, which suffices for the description of the present invention. In FIG. 2, the shadow mask 13 has a gun side 20 and a screen side 21, the apertures are indicated by means of reference numeral 22 and the shadow mask material by means of reference numeral 23. In a state of the art production process of a shadow mask, the pattern of apertures is formed by a photographic process followed by an etching process. The etching process is in general responsible for the crater-shaped apertures. Because a photosensitive layer is applied on both sides of the shadow mask 13 and the shadow mask 13 is etched from both sides, the apertures obtain their specific double crater shape formed by the walls 24, 25. The points 27 where the etching regions of the gun side 20 and the screen side 21 meet, determine the transmission of the shadow mask 13 for passage of the electron beam 28. The shape of the apertures 22 is in principle the same for colour display tubes having a screen 6 with a dotted structure or a striped structure. Although, for colour display tubes 1 with a slotted type of shadow mask 13, the vertical dimensions of the apertures 22 are significantly larger than the horizontal dimensions. In aperture-grill type shadow masks 13, only the horizontal cross-section of the aperture is of importance. Note that horizontal and vertical in general means in the direction of the line and frame direction respectively.

FIG. 3 shows three different electron reflection processes. The electron beams 7, 8 and 9, generated by the electron gun 10, are partly interrupted by the shadow mask 13. Of the electrons that hit the metal of the shadow mask 13, a part is reflected into the cone space 40. After a number of reflections, amongst others from the inner magnetic shielding 39, these electrons may reach the screen 6 and contribute to the stray light in a way that is more or less uniform over the entire screen 6. In FIG. 3 this process is represented by A.

A second process, represented by B, is caused by electrons that have passed the shadow mask 13 and are reflected by the screen 6. After one or more reflections between the shadow mask 13 and the screen 6 they may reach the screen 6 to be absorbed by the phosphors and then contribute to the stray light as well. Process C describes the electrons that are reflected at the walls 24 of the apertures 22 of the shadow mask 13 and that will reach the phosphors on the screen in a different position, also causing stray light. A basic difference between these processes is the distance over which stray light is formed. Process A causes stray light over the entire screen 6, while the processes B and C cause stray light in the vicinity of the position where the primary beam—that is the beam formed by electrons that reach the screen without any reflections—impinges on the screen 6. All three processes cause stray light that is more or less equally divided among the three colors of the phosphor, resulting in stray light that is whitish in colour. This stray light is detrimental to the picture quality of a colour display tube 1 because it diminishes the contrast performance. Contrast is defined as the ratio between the amount of light that is generated by the colour display tube 1 on a bright white area and the amount of light coming from a black—no current—area. Apart from the effect on the contrast, stray light is also bad for the colour rendition because adding a whitish stray light to the primary colors diminishes the colour gamut. Because the stray light caused by process A is distributed over the entire screen, it also effects the contrast over the entire screen which, for that reason, is referred to as the long-distance contrast. The processes B and C influence only the neighborhood of the position where the primary electrons hit the screen and consequently these processes influence the short-distance contrast.

It will be clear that the contrast performance can be optimized by taking care that all the electrons are absorbed by the shadow mask 13. In this situation, no secondary—reflected —electrons are present and stray light is not generated. However, this choice has a serious drawback. If all the electrons that hit the metal of the shadow mask 13 are captured, the temperature of the shadow mask 13 goes up, leading to deformations of the shadow mask 13. This kind of deformations causes a phenomenon that is commonly referred to as doming and leads to misregistrations of the electron beams on the screen. As a result the picture on the colour display tube 1 will show discolourations.

For these reasons, it is always necessary to choose a compromise between the doming performance and the contrast performance of a colour display tube 1. In general, a picture of a colour display tube 1 is appreciated by a viewer when the short-distance contrast performance is good. In order to achieve this object, it is desirable to have a low number of electron reflections at the shadow mask 13 relating to the processes B and C, and to allow an amount of reflections relating to process A that is required for obtaining a good doming performance of the colour display tube 1. This can be realized by providing the shadow mask 13 at the gun side 20 with a coating comprising a heavy metal or an oxide thereof. Heavy metals, especially those with an atomic number that is higher than 70, have a high electron backscatter coefficient, resulting in a shadow mask temperature that is lower compared to the situation without this coating. The doming performance of the colour display tube 1 is improved by this measure. In practice, a layer of bismuth oxide (Bi₂O₃) has proven to be very efficient and is widely applied for that reason. Other materials that may be used for this purpose at the gun side of the shadow mask 13 are tungsten oxide (WO₃) or tungsten carbide (WC). For realizing a low electron backscattering in the processes B and C, it is required to provide the shadow mask 13 at the screen side 21 and at the walls 24, 25 of the apertures 22 with a coating that comprises material with a low atomic number Z. In practice, materials that have been found to give good results are selected from the group comprising for instance aluminium oxide (Al₂O₃), silicon oxide (SiO₂) and boron nitride (BN); in addition, carbides may be used. In present day colour display tubes, preferably a coating of Al₂O₃ is applied. Because process C relates to electrons reflected at the walls 24, 25 of the apertures 22, it is clear that a coating applied at the gun side 20 of the shadow mask 13 should leave the walls 25 of the apertures 22—that is the crater at the gun side—free from a coating which comprises a heavy metal or oxide thereof.

A shadow mask 13 according to the invention for use in a colour display tube 1 can be manufactured by different methods. By way of non limitative example, a method of manufacturing such a shadow mask 13 will be described and illustrated by means of FIG. 4. FIG. 4A shows the starting point: as the basic material for shadow masks 13 a sheet of metal 43 is used. This metal may be iron, for akoca masks, or it may be an iron-nickel alloy used for invar or invar-like shadow masks with a much lower expansion coefficient than iron shadow masks. FIG. 4B shows the situation where the sheet of metal 43 is covered with a layer of a heavy metal 44, for instance tungsten. Then, in a manner similar to the present day photochemical etching process, the pattern of apertures is applied to this sheet of metal 43 including the heavy metal layer 44. In order to have a good doming performance, it is important that the shadow mask 13 has a high electron backscattering coefficient at the gun side 20. So, at least the gun side 20 of the shadow mask 13 should be covered with the heavy metal layer 44. Since the pattern of apertures 22 is formed after the heavy metal layer 44 is applied, the walls 24, 25 of the crater-shaped apertures 22 in the shadow mask 13 do not have a coating of a heavy metal. After this process step the shadow mask 13 as shown in FIG. 4C is obtained. Note that the numerals in this Figure are comparable to those in FIG. 2, shows a detail of the shadow mask 13. This is advantageous for the short distance contrast performance of the colour display tube 1 because the number of electrons that are reflected at the walls 24, 25 of an aperture 22 and that reach the screen 6 near to the position where the primary beams 7, 8, 9 impinge upon the screen 6 is much lower. In FIG. 4B, the heavy metal layer (44) is only shown at the gun side (20) of the shadow mask. This should not be considered as limitative. It is also possible to apply the heavy metal layer (44) at both sides of the shadow mask (13). This has advantages with respect to the etching process and it counteracts a possible bimetallic action of the shadow mask (13).

After the pattern of apertures 22 is etched in the sheet of metal, the still flat shadow mask 13 is annealed at a temperature of about 850° C. in a reducing atmosphere. This process serves to facilitate the drawing process of the shadow mask 13. This temperature limits the number of heavy metals to be used, for instance tungsten with a melting point of 3400° C. is suited, while bismuth and lead, having melting points of 271° C. and 327° C. respectively, are not suited to be applied before the annealing process because they will melt during this process.

After the annealing process, the shadow mask 13 is drawn, in case a curved mask is required, to obtain the required shape. In general, this drawing process is followed by a blackening process, in which the shadow mask is oxidized at a temperature of about 500-650° C. In case the shadow mask is uncoated, the iron is oxidized to form a layer of black iron-oxide (Fe₃O₄). For shadow masks provided with a layer of tungsten (W) during the blackening process WO₃ is formed. The backscatter coefficients for Fe₃O₄ and WO₃ are 0.22 and 0.40, respectively (H. Niedrig, ‘Electron backscattering from thin films’ (Journal of Applied Physics 53(4), April 1982)). This clearly indicates the improvement in backscatter performance of the shadow mask 13 by providing it with a tungsten layer. This layer further increases the emissivity of the shadow mask 13, leading to a lower temperature and consequently to a better doming performance.

The contrast performance may be further improved by providing the screen side 21 of the shadow mask 13 and preferably also the walls 24, 25 of the apertures 22 in the shadow mask 13 with a coating 45—see FIG. 4D—with a low electron backscattering coefficient, like for instance Al₂O₃, SiO₂ or BN. A coating of these materials may be applied by spraying or by electrophoretic deposition. The latter process has been disclosed in United States patent specification U.S. Pat. No. 6,008,571.

In summary, in a colour display tube 1, the shadow mask 13 serves as the colour selective element. The major part of the electrons emitted by the electron gun 10 are intercepted by the shadow mask 13. These electrons can be absorbed by the shadow mask 13 or they can be reflected. If the electrons are absorbed, the shadow mask 13 is heated, as a result of which it will be deformed leading to misregistration of the electron beams 7, 8, 9 when they impinge upon the phosphor screen 6, causing colour impurities on the colour display tube 1. This phenomenon is called doming. If the electrons are reflected, degradation of the contrast performance will occur because the reflected electrons hit the phosphor screen 6 at totally different positions, leading to the generation of stray light. Both the doming and the contrast performance are important for the quality of a colour display tube 1. The problem however is that in order to optimize the doming performance all electrons should be reflected and to optimize the contrast performance all electrons should be absorbed by the shadow mask 13. This invention provides a solution for this problem in that the shadow mask 13 is coated only at the surface at the gun side 20 with a heavy metal or an oxide thereof having a high backscatter coefficient, which has a favourable effect on doming. Preferably, the screen side 21 of the shadow mask 13 and the walls 24, 25 of the apertures 22 are covered with a coating with a low backscatter coefficient, reflecting in an improvement of the contrast in the vicinity of the position of the electron beam 7, 8, 9. As regards visual perception a very good compromise is achieved between contrast and doming performance—i.e. colour purity—of a colour display tube 1.

1. A colour display (1) tube comprising an electron gun (10), a display window (3) with a screen (6), and a colour selection electrode (12) having a shadow mask (13) positioned between the electron gun (10) and the screen (6), which shadow mask (13), having a gun side (20) and a screen side (21), is provided with a pattern of apertures (22), which apertures (22), at least at the gun side (20), are shaped like a crater, the shadow mask (13) being provided at the gun side (20) with a coating with a high electron backscatter coefficient and at the screen side (21) with a coating with a low electron backscatter coefficient, characterized in that the coating with the high electron backscatter coefficient on the gun side (20) of the shadow mask (13) leaves the craters of the apertures (22) free.

2. A colour display tube (1) as claimed in claim 1, characterized in that the coating at the gun side (20) comprises a heavy metal or an oxide of a heavy metal, which heavy metal has an atomic number Z of at least 70.

3. A colour display tube (1) as claimed in claim 1 or 2, characterized in that the coating at the screen side (21) comprises a light metal or an oxide of a light metal, which light metal has an atomic number Z which does not exceed 20.

4. A colour display tube (1) as claimed in claim 2, characterized in that the coating at the gun side (20) comprises a material of the group formed by Bi₂O₃, WO₃, WC.

5. A colour display tube (1) as claimed in claim 3, characterized in that the coating at the screen side (21) comprises a material of the group formed by Al₂O₃, SiO₂, BN.

6. A colour display tube (1) as claimed in claim 1, 2, 3, 4 or 5, characterized in that the craters of the apertures (22) at the gun side (20) of the shadow mask (13) are coated with the coating provided on the screen side (21) of the shadow mask (13).

7. A shadow mask (13) for use in the colour display tube (1) according to claims 1-6.

8. A method of manufacturing a shadow mask (13) having a gun side (20) and a screen side (21) for use in a colour display tube (1), which shadow mask (13) is formed from a sheet of metal (43), characterized in that said method comprises the steps of covering the sheet of metal (43) with a layer of a heavy metal (44) and, subsequently, applying the pattern of apertures (22) to said sheet of metal (43).

9. A method as claimed in claim 8, characterized in that the layer of a heavy metal (44) is at least applied on the gun side (20) of the shadow mask (13).

10. A method as claimed in claim 8 or 9, characterized in that the layer of a heavy metal (44) is applied by evaporation, sputtering or electrochemical plating.

11. A method as claimed in claim 8, 9 or 10, characterized in that the pattern of apertures (22) is applied by a photochemical etching process.

12. A method as claimed in claim 8, 9, 10 or 11, characterized in that the layer of a heavy metal (44) comprises tungsten (W).

13. A method as claimed in claim 12, characterized in that the layer comprising tungsten has a thickness of about 0.5 μm.

14. A method as claimed in claim 8, 9, 10, 11, 12 or 13, characterized in that the screen side (21) of the shadow mask (13) is covered with a layer with a low backscatter coefficient.

15. A method as claimed in claim 14, characterized in that the coating at the screen side (21) comprises a material of the group formed by Al₂O₃, SiO₂, BN.
